(19) United States
(12) Patent Application Publication
(10) Pub. No.: US 2006/0130898 A1
(43) Pub. Date: Jun. 22, 2006

(54) Domestic water distribution system

(76) Inventor: Karim Esmailzadeh, Rochester, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 11/018,460

(22) Filed: Dec. 21, 2004

(51) Int. Cl. G05D 7/00

(52) U.S. Cl. 137/236.1

(57) ABSTRACT

In a water distribution system having a number of first water pipes and second water pipes connected to the first water pipes by connections in which the second water pipe is connected to the side of the first water pipe, a method of preventing the build-up of sludge in the first water pipe. The method consists of the steps of: disconnecting the second water pipe from the first water pipe; and reconnecting the second water pipe to the first water pipe so that the second water pipe is connected to the bottom of the first water pipe. An apparatus preventing the build-up of sludge in the first water pipe consists of a connection from the bottom of the first water pipe to the second water pipe. A method of preventing the build-up of sludge in the first water pipe consists of the steps of disconnecting the second water pipe from the first water pipe; and reconnecting the second water pipe to the first water pipe so that the second water pipe is connected eccentrically to the first water pipe.

### BACKGROUND OF THE INVENTION

The present invention relates to an apparatus and method for reducing and/or eliminating sludge in a domestic water distribution system.

City water is distributed to consumers from some central facility such as a water tower or pumping station. As shown in FIG. 1, the water is distributed through street water mains M that are embedded below ground along main streets. At various points along these street water mains, branch water mains B are connected. The branch water mains B also have fire hydrants H attached at various points by extension pipes E1 and stop valves V1. Consumers (businesses and homes) are also connected to the branch water mains B by extension pipes E2 and curb stop valves V2 to the water meter WM in each building.

U.S. Pat. Nos. 6,170,514 and 6,487,498 disclose an apparatus and method for flushing sludge from the branch water mains B through the fire hydrants H. However, there is also a need for preventing the build-up of sludge anywhere in the domestic water distribution system.

Sludge can accumulate at any point where two pipes are joined in such a manner that gravity permits sludge to accumulate below the pipe junction. In particular, FIG. 2 shows the junction between a branch water main B and an extension pipe E1 to a fire hydrant H. Because the extension pipe E1 is joined to the side of the branch water main B, typically by a side tee 16, sludge can accumulate below the junction. Similarly, as shown in FIG. 3, sludge can accumulate at the junction between the branch water main B and the extension pipe E2 to the consumer, again because the extension pipe E2 is joined to the branch water main B by a corporation cock C on the side of the branch water main.

There is a need for an apparatus and method for preventing such sludge build-up.

In addition, with the increased frequency of terrorist attacks, there is a need for an apparatus for preventing a terrorist in a building from contaminating water flowing in the branch water main B.

### SUMMARY OF THE INVENTION

In a water distribution system having a number of first water pipes and second water pipes connected to the first water pipes by connections in which the second water pipe is connected to the side of the first water pipe, a method of preventing the build-up of sludge in the first water pipe. The method consists of the steps of: disconnecting the second water pipe from the first water pipe; and reconnecting the second water pipe to the first water pipe so that the second water pipe is connected to the bottom of the first water pipe. An apparatus preventing the build-up of sludge in the first water pipe consists of a connection from the bottom of the first water pipe to the second water pipe. A method of preventing the build-up of sludge in the first water pipe consists of the steps of disconnecting the second water pipe from the first water pipe; and reconnecting the second water pipe to the first water pipe so that the second water pipe is connected eccentrically to the first water pipe.

A principal object and advantage of the present invention is that it prevents the build-up of sludge in water pipes in water distribution systems.

Another principal object and advantage of the present invention is that it prevents sludge build-up with simple changes to pipe connections.

### BRIEF DESCRIPTION OF DRAWINGS

FIG. 1 is a schematic of an existing domestic water distribution system FIG. 2 is a cross-section at approximately the lines 2 of FIG. 1.

FIG. 3 is a cross-section at approximately the lines 3 of FIG. 1.

FIG. 4 is a schematic showing definitions used in the present patent application.

FIG. 5A is a schematic similar to FIG. 2.

FIG. 5B is a schematic similar to FIG. 3.

FIG. 6 is a schematic of one embodiment of the method of the present invention.

FIG. 7 is a schematic similar to FIG. 1 showing changes made to the system in various aspects of the present invention.

FIG. 8A is a schematic similar to FIG. 6 showing one embodiment of the apparatus of the present invention.

FIG. 8B is another view of the embodiment of FIG. 8A.

FIG. 9 is a schematic showing a second embodiment of the apparatus of the present invention.

FIG. 10 is a schematic showing a third embodiment of the apparatus of the present invention.

FIG. 11 is a schematic showing how pipes in an existing water distribution system are joined concentrically, allowing sludge build-up.

FIG. 12 is a schematic showing a method of preventing sludge build-up by changing the pipe junctions to eccentric ones.

### DETAILED DESCRIPTION OF THE PREFERRED EMBODIMENT

In this patent application, with reference to a water pipe, “side” shall be defined with reference to FIG. 4 and shall include any point on the pipe P in which the force of gravity G acts upon sludge S in the pipe at an angle substantially greater than zero degrees, and “bottom” shall be defined with reference to FIG. 4 and shall include any point on the pipe in which the force of gravity acts upon the sludge in the pipe at an angle of substantially zero degrees. “Disconnecting” and “reconnecting” shall be defined as any step in which a first pipe can be moved relative to a second pipe.

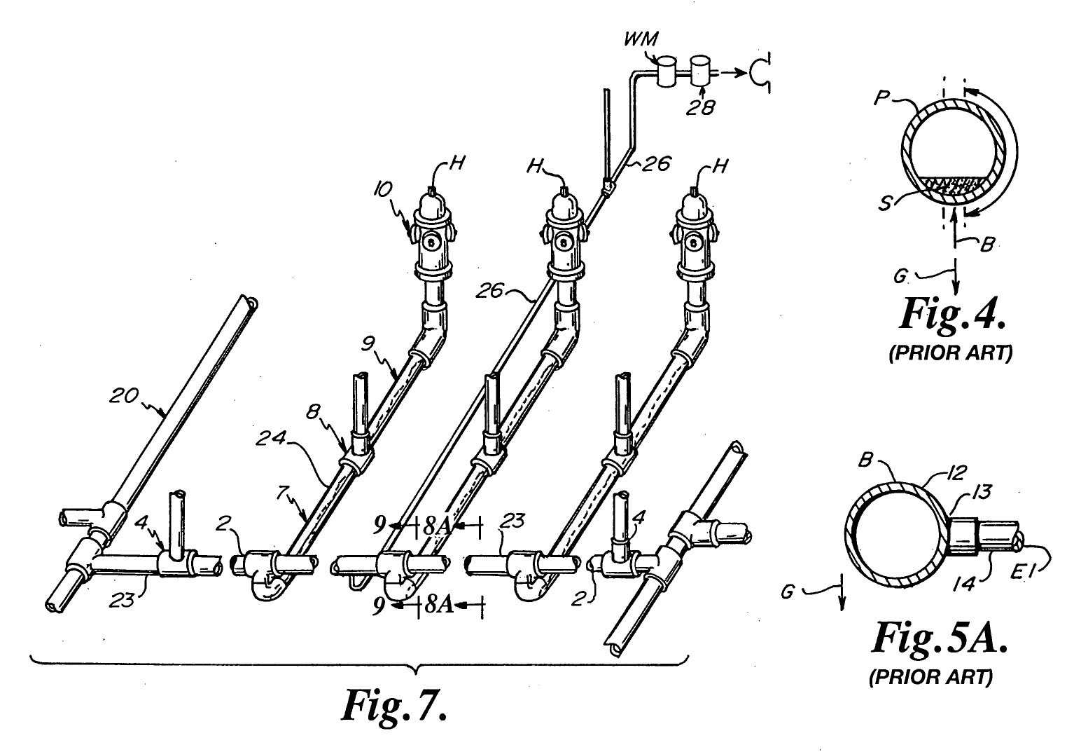

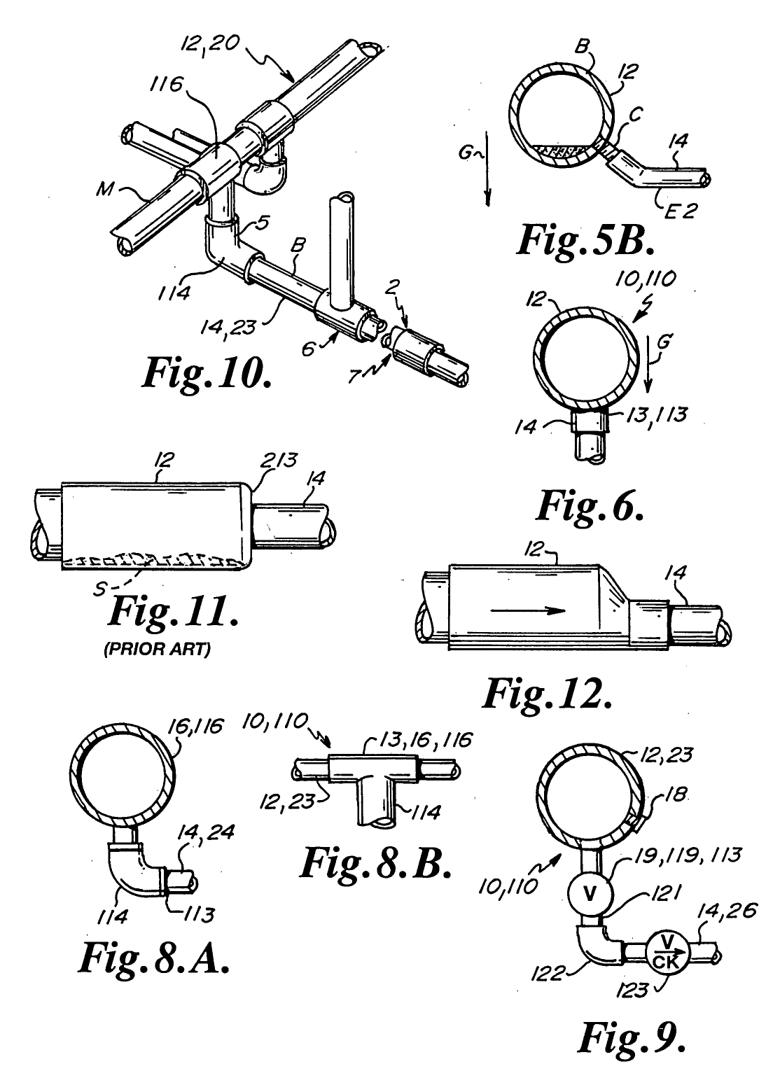

In one aspect, the present invention 10 comprises a method of preventing the build-up of sludge in a water distribution system having a number of first water pipes 12 and second pipes 14 connected to the first pipes 12 by connections 13 in which the second water pipes 14 are connected to the side of the first water pipe 12 (FIG. 5A), comprising the steps of: disconnecting the second water pipe 14 from the first water pipe 12; and reconnecting the second water pipe 14 to the first water pipe 12 so that the second water pipe 14 is connected to the bottom of the first water pipe 12 (FIG. 6).

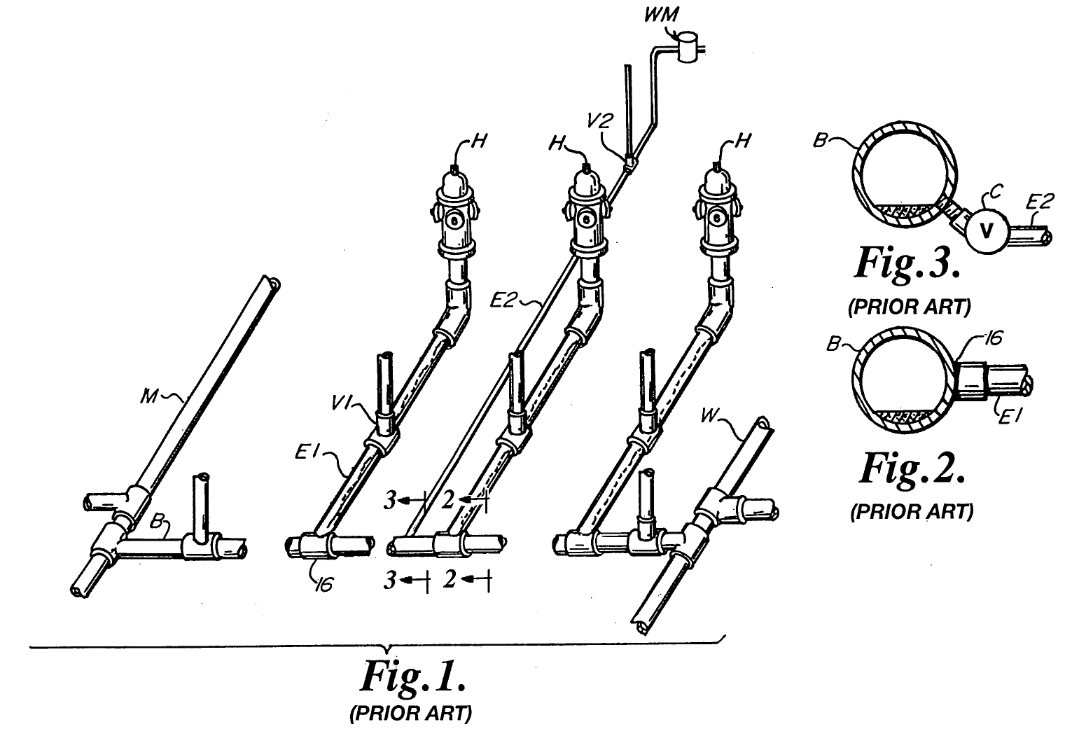

In one embodiment, the connection 13 is a side tee 16: The first pipe 12 and the second pipe 14 are disconnected and the side tee 16 is then rotated 90 degrees and then the second pipe 14 is re-connected to the bottom of the first pipe 12. (FIGS. 1, 7, 8A, 8B)

In a second embodiment, the connection is a cock 18. The first pipe 12 and second pipe 14 are disconnected, the cock is plugged, and the second pipe 14 is connected to a new 19 cock at the bottom of the first pipe 12. (FIGS. 7 and 9)

In one embodiment (FIG. 10), the first water pipe 12 is a street water main 20 and the second water pipe 14 is a branch water main 23.

In one embodiment (FIGS. 7, 8A, 8B), the first water pipe 12 is a branch water main 23 and the second water pipe 14 is an extension pipe 24 to a fire hydrant H.

In one embodiment (FIGS. 7, 9), the first water pipe 12 is a branch water main 23 and the second water pipe 14 is an extension pipe 26 to a consumer C.

In one aspect, the present invention 110 comprises an apparatus preventing the build-up of sludge in a water distribution system having a number of first water pipes 12 and second pipes 14 connected to the first pipes 12 by connections 13 in which the second water pipes 14 are connected to the side of the first water pipe 12 (FIG. 5), comprising a connection 113 from the bottom of the first water pipe 12 to the second water pipe 14. (FIG. 6).

In one embodiment, the connection 113 is a tee 116. Preferably, the apparatus 110 further comprises a 90 degree elbow 114 between the tee 116 and the second water pipe 14. (FIGS. 7, 8A, 8B).

In one embodiment, the connection 113 is a cock 119. Preferably, the apparatus 110 further comprises an extension pipe 121 and a 90 degree elbow 122 between the cock 119 and the second water pipe 14. (FIGS. 7 and 9) The apparatus 110 may further comprise a check valve 123 permitting water to flow from the first water pipe 12 to the second water pipe 14 and preventing water flowing from the second water pipe 14 to the first water pipe 12. This prevents a terrorist from introducing a contaminant into the distribution system from within a building connected to the second water pipe 14.

In one embodiment (FIG. 10), the first water pipe 12 is a street water main 20 and the second water pipe 14 is a branch water main 23.

In one embodiment (FIGS. 7, 8A, 8B), the first water pipe 12 is a branch water main 23 and the second water pipe 14 is an extension pipe 24 to a fire hydrant H.

In one embodiment (FIGS. 7, 9), the first water pipe 12 is a branch water main 23 and the second water pipe 14 is an extension pipe 26 to a consumer C.

Operation of the first two aspects of the invention will now be described.

As previously described, extension pipes E1 to fire hydrants in existing domestic water distribution systems are connected to branch water mains B by side discharge tees such that the extension pipe E1 is connected a few inches above the bottom of the branch water main B. As shown in FIG. 5A, sludge then builds up in the branch water main B. By simply disconnecting the side discharge tee, rotating it 90 degrees, and reconnecting it to the main 23 and extension pipe 24, there is no opportunity for sludge to build up because the force of gravity causes water flowing from the main 23 to the extension pipe 24 to carry the sludge with it. FIGS. 7, 8A, and 8B show the result.

Similarly, extension pipes E2 to consumers in existing domestic water distribution systems are connected to branch water mains B by corporation cocks C on the side of the branch water main. As shown in FIG. 5B, sludge then builds up in the branch water main B. By removing and plugging the corporation cock C and tapping the bottom of the branch water main 23 and inserting a new corporation cock 19 (FIG. 9), there is no opportunity for sludge to build up because the force of gravity causes water flowing from the main 23 to the extension pipe 26 to carry the sludge with it.

For water distribution systems going into new developments, there is also an opportunity to re-design the connections between the street water mains M and the branch water mains B. As shown in FIG. 10, the street water mains M, 20 are connected to the branch water mains B, 14 by tees 116 and 90 degree elbows 114 so that water flowing from the street water main 20 to the branch water main 23 takes sludge with it under the force of gravity.

In one aspect, the present invention comprises a method of preventing the build-up of sludge in a water distribution system having a number of first water pipes 12 and second pipes 14 connected to the first pipes 12 by connections 213 in which the second water pipes 14 are connected concentrically to the first water pipe 12 (FIG. 11), comprising the steps of: disconnecting the second water pipe 14 from the first water pipe 12; and reconnecting the second water pipe 14 to the first water pipe 12 so that the second water pipe 14 is connected eccentrically to the first water pipe 12 (FIG. 12).

As seen in FIG. 11, when two pipes of unequal diameter are connected concentrically, there is an opportunity for sludge S to build up in the pipe having the larger diameter. If instead (FIG. 12), the pipes are connected eccentrically, this does not happen.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. In a water distribution system having a number of first water pipes and second water pipes connected to the first water pipes by connections in which the second water pipe is connected to the side of the first water pipe, a method of preventing the build-up of sludge in the first water pipe, comprising the steps of:
(a) disconnecting the second water pipe from the first water pipe; and
(b) reconnecting the second water pipe to the first water pipe so that the second water pipe is connected to the bottom of the first water pipe.

2. The method of claim 1, wherein the connection is a tee, and wherein the tee is rotated 90 degrees from its existing position.

3. The method of claim 1, wherein the connection is a cock, and wherein the cock is plugged and a new cock is connected to the bottom of the first water pipe.

4. The method of claim 1, wherein the first water pipe is a street water main and the second water pipe is a branch water main.

5. The method of claim 1, wherein the first water pipe is a branch water main and the second water pipe is an extension pipe to a fire hydrant.

6. The method of claim 1, wherein the first water pipe is a branch water main and the second water pipe is an extension pipe to a consumer.

7. In a water distribution system having a number of first water pipes and second water pipes connected to the first water pipes by connections in which the second water pipe is connected to the side of the first water pipe, an apparatus preventing the build-up of sludge in the first water pipe, the apparatus comprising a connection from the bottom of the first water pipe to the second water pipe.

8. The apparatus of claim 7, wherein the connection is a tee.

9. The apparatus of claim 8, further comprising a 90 degree elbow between the tee and the second water pipe.

10. The apparatus of claim 7, wherein the connection is a cock.

11. The apparatus of claim 10, further comprising an extension pipe and a 90 degree elbow between the cock and the second water pipe.

12. The apparatus of claim 11, further comprising a check valve permitting water to flow from the first water pipe to the second water pipe and preventing water flowing from the second water pipe to the first water pipe.

13. The apparatus of claim 8, wherein the first water pipe is a street water main and the second water pipe is a branch water main.

14. The apparatus of claim 8, wherein the first water pipe is a branch water main and the second water pipe is an extension pipe to a fire hydrant.

15. The apparatus of claim 11, wherein the first water pipe is a branch water main and the second water pipe is an extension pipe to a consumer.

16. In a water distribution system having a number of first water pipes and second water pipes connected to the first water pipes by connections in which the second water pipe is connected concentrically to the first water pipe, a method of preventing the build-up of sludge in the first water pipe, comprising the steps of:
(c) disconnecting the second water pipe from the first water pipe; and
(d) reconnecting the second water pipe to the first water pipe so that the second water pipe is connected eccentrically to the first water pipe.
